(19) United States
(12) Patent Application Publication
(10) Pub. No.: US 2019/0060866 A1
(43) Pub. Date: Feb. 28, 2019

(54) CHEMICAL SAMPLING IN HIGH WATER ENVIRONMENTS

(71) Applicant: BAE SYSTEMS Information and Electronic Systems Integration Inc., Nashua, NH (US)

(72) Inventors: Michael J. BOWERS, II, Sykesville, MD (US); Pierre-Alain S. AUROUX, Rockville, MD (US); Christopher S. BADORREK, Hagerstown, MD (US); Myeongseob KIM, Ellicott City, MD (US); John E. KING, Ellicott City, MD (US); Tadd C. KIPPENY, Pasadena, MD (US)

(21) Appl. No.: 15/690,507

(22) Filed: Aug. 30, 2017

(51) Int. Cl. B01J 20/20; C01B 32/318; B01J 20/28; B01J 20/282; B01J 20/286; G01N 1/40

(52) U.S. Cl. CPC B01J 20/20; C01B 32/318; B01J 20/28083; C01P 2006/16; B01J 20/286; G01N 1/405; B01J 20/282

(57) ABSTRACT

The system and method of using carbide derived carbon as a sorbent material in high humidity environments. In some cases, the sorbent material is used for breath analysis. In some cases, the sorbent material is used in a gas mask. In certain cases, the sorbent material is functionalized for detection or capture of particular chemicals.

### STATEMENT OF GOVERNMENT INTEREST

This disclosure was made with United States Government support under Contract No. HR0011-08-C-0056 awarded by the Defense Advanced Research Projects Agency (DARPA). The United States Government has certain rights in this disclosure.

### FIELD OF THE DISCLOSURE

The present disclosure relates to chemical sampling and more particularly to chemical sampling in high humidity environments.

### BACKGROUND OF THE DISCLOSURE

Chemical detection is a widely used tool for applications ranging from analysis of laboratory samples to field applications such as breath analysis, explosives and narcotics detection, and environmental monitoring. Most of these applications require sampling (the collection of samples) in uncontrolled humidity (e.g., air outdoors), high humidity (e.g., breath), or even water (e.g., monitoring water for contaminants). The presence of water in either gaseous or liquid phase is problematic to many of the most sensitive detection techniques because the water present in a given sample could easily be present in quantities that are orders of magnitude greater than any chemicals of interest, thus overwhelming the detector's ability to detect the less concentrated chemical. Additionally, when a chemical sample is concentrated prior to introduction to a detecting apparatus through means of a sorbent, the presence of high amounts of water limit the sorbent's ability to concentrate the chemical of interest or may even completely prevent adsorption. This also has the effect of limiting the sensitivity of the detection technique.

### SUMMARY OF THE DISCLOSURE

One aspect of the present disclosure is a method of chemical sampling comprising, providing a carbide derived carbon fabricated by partially or completely depleting a metal from a metal carbide composition; and using the carbide derived carbon as a sorbent and preconcentrator in a high humidity or aqueous environment, wherein the carbide derived carbon retains its removal capabilities after 7 days at more than 80% relative humidity.

In one embodiment of the method of chemical sampling, the carbide derived carbon is functionalized. In another embodiment of the method of chemical sampling, the carbide derived carbon sorbent is present in a breath analyzer. In yet another embodiment of the method of chemical sampling, the carbide derived carbon sorbent is present in a gas mask.

In certain embodiments of the method of chemical sampling, the carbide derived carbon has a pore width of between 23 and 27 Angstroms.

Another aspect of the present disclosure is a carbide derived carbon material comprising, a pore width of between 23 and 27 Angstroms; and chemical removal capabilities that are retained after 7 days at more than 80% relative humidity, wherein the carbide derived carbon is fabricated by partially or completely depleting a metal from a metal carbide composition.

In one embodiment of the carbide derived carbon material, the carbide derived carbon is functionalized. In another embodiment of the carbide derived carbon, the carbide derived carbon is used as a sorbent and preconcentrator in a high humidity or aqueous environment. In yet another embodiment of the carbide derived carbon, the carbide derived carbon is used as a sorbent in a breath analyzer. In still another embodiment of the carbide derived carbon, the carbide derived carbon is used as a sorbent in a gas mask.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1A is a table showing surface area, pore volume, and pore size distribution of the functionalized material according to one embodiment of the present disclosure.

FIG. 1B is a table showing surface area, pore volume, and pore size distribution of the functionalized material according to one embodiment of the present disclosure.

FIG. 2A is a table showing XPS elemental analysis according to one embodiment of the present disclosure.

FIG. 2B is a table showing XPS analysis: type of bonding according to one embodiment of the present disclosure.

FIG. 3 is a table of results for an aging test according to one embodiment of the present disclosure.

FIG. 4 is a table showing Boehm titration and bulk analysis of different types of acidic groups according to one embodiment of the present disclosure.

FIG. 5 is a table comparing existing gas mask filters with CDC filters according to one embodiment of the present disclosure.

FIG. 6A is a plot of breath analysis using CDC according to one embodiment of the present disclosure.

FIG. 6B is a plot of breath analysis using CDC according to one embodiment of the present disclosure.

### DETAILED DESCRIPTION OF THE DISCLOSURE

One embodiment of the system of the present disclosure comprises a highly porous material, carbide-derived carbon (CDC), and a method for its use as a chemical sampler in high-humidity or aqueous sampling. Remarkably, CDC adsorbs a very broad range of chemicals while simultaneously adsorbing very little water. This makes CDC highly desirable as a sorbent and preconcentrator when sampling in high-humidity or aqueous environments.

In some cases, the CDC can be made from any carbide by the removal of the metal element(s). Some examples include, but are not limited to: silicon carbide, titanium carbide, iron carbide, molybdenum carbide, cobalt carbide, tungsten carbide, nickel carbide. By varying the starting material and/or reaction conditions, it is possible to tailor the porosity of the CDC to favor adsorption of certain molecules; the CDC may be partially or fully depleted of metal atoms, which also can enhance the adsorption of specific molecules. In certain embodiments, the CDC is treated post-fabrication to enhance adsorption of specific molecules. Some post-fabrication treatments include, but are not limited to: plasma treatment, exposure to chemicals or mixtures of chemicals (e.g., hydrogen gas or hydrochloric acid), and attachment of specific chemicals.

In some cases, the CDC may occur in the form of a powder, a fiber, a solid foam, a mesh, a solid object, or the like. The CDC may exist as a lone material or as a skin on the surface of an underlying carbide structure. In some embodiments, the CDC may be used in high-water and/or arid environments. Some specific applications that have already been tested include filtration of organic molecules from water, trace gas detection in high-humidity environments (including ship-board), and breath analysis. Several other applications are envisioned, including analysis of bodily fluids (e.g., sweat, blood, urine), and monitoring of both natural (e.g., lakes or outside air) and manmade (e.g., buildings or tunnels) environments.

Those skilled in the art will appreciate that pre-concentrators such as sorbent materials (sorbents) are widely used in chemical sampling because they allow the user to concentrate chemicals that would otherwise be too sparse to detect. However, the presence of water hinders chemical sampling in two ways: (1) if a chemical is hydrophilic, in a high-humidity or aqueous environment it may remain solvated by water molecules (even in gaseous form) rather than adsorbing to the sorbent surface; (2) large quantities of water may occupy all available surface sites on the sorbent, reducing the ability of other molecules to adsorb and also creating a large detector response that may swamp out the signals of trace chemicals.

Currently, sorbents designed to adsorb broad classes of chemicals suffer in high-humidity environments due to the above-mentioned reasons. Even some sorbents that target specific chemicals or classes of chemicals have degraded performance in high-humidity environments, depending on the affinity of water for the sorbent. CDC has the peculiar property that it has medium-to-high affinity for almost any chemical except water. Thus, it can be used for chemical sampling in both arid and humid environments, as well as in water.

In certain embodiments, there is no need to switch sorbent type when moving from one environment to another. Moreover, because the system of the present disclosure adsorbs such a wide range of chemicals, it can be used when the chemicals to be detected are unknown, and it can be used to detect unexpected chemicals when a priori assumptions have been made about what chemicals are present. As an example, during shipboard testing (a high-humidity environment) of the CDC sorbent of the present disclosure, a large quantity of Freon was detected in one room, where no Freon was anticipated. This led to the discovery of a previously undetected Freon leak. In another example, unexpected chemicals in a sample in a neighborhood during the height of summer (100 degrees F. and high humidity) using the CDC sorbent of the present disclosure revealed the presence of a previously unknown woodshop.

Those skilled in the art will also appreciate that the composition and method of the disclosure could also be used for food monitoring to indicate spoilage due to the release of gases that food spoilage releases. The system of the present disclosure could also be used in monitoring of industrial processes (e.g., process monitoring, quality control, and detection of leaks, spills, hazardous chemicals, and the like). It is noted that CDC can be used to detect all phases of matter (gas, liquid, solid particulate, aerosol, etc.). In some cases, the system of the present disclosure could be used in biological detection (e.g., spores).

One aspect of the present disclosure is the use of carbide-based material as the next generation material in filtering specific target gases for the warfighter. The filtration efficiency was determined under laboratory conditions (e.g. gas flow of 20 ml/min over about 20-40 mg sorbent) scaled to mimic average breathing rates after moderate exercise (e.g., 30 L/min over about 120 g sorbent) with at least two degrees of relative humidity (RH): dry (RH=0%) and humid (RH=80%).

Large-scale production was achieved. An increase in CDC fabrication and functionalization capabilities of 40× and 26×, respectively, was achieved. In addition, characterization tests indicated that there was no loss in effective loading during residual testing. Furthermore, aging testing demonstrated that the CDC retains its removal capabilities after 7 days at 45° C. and 85% relative humidity. XPS analysis and Boehm titration demonstrated that the functionalization introduces carboxylic acid group. The surface area analysis and the micropore volume analysis indicated that the functionalization is performed within the core without noticeable changes in the pore size distribution.

CDC fabrication: a 36 inch tube furnace was used and up to 75-100 grams could be treated per run without significant modifications of the set-up. Functionalization: Various protocols were tested. (i) The functionalization treatment that was originally performed consisted in preparing CDC in a 40 ml vial and adding acid. The vial was then placed in a heating block and heated. Then acid-treated CDC was subsequently washed with DI water until pH reaches 7. That type of approach was easily scaled-up. The scale-up process was increased by using a bigger flask and ensuring that the kinetics of the reaction remained unchanged. A vapor treatment was also attempted in order to minimize the generation of waste product. CDC was placed on the frit inside of custom made Claisen Condenser and put the condenser to the 100 ml round bottom flask with 50 ml of acid. The condenser was wrapped around by heating tape to maintain temperature above boiling point of acid. Then vapor treated CDC was washed with DI water until pH reaches 7. Finally, dry methods were also implemented for further ease production and waste management. They consisted of a UV/Ozone treatment and Plasma treatment. As can be seen, acid treatment in the liquid phase using a large vial provided the best compromise for large scale production with high effective loading.

Two parameters were investigated: the process temperature and the particle size. Within experimental error, we reached our effective loading target. Two additional samples were used for XPS analysis and aging experiment and subsequently delivered. In addition to micro-breakthrough analysis, multiple tests were performed on the functionalized material, namely pore size distribution, residual capacity, aging, XPS analysis, and Boehm titration.

Residual capacity: The effective loading of a dry sample was first assessed to establish a baseline value. To determine the residual capacity, the sample was then humidified for 4 hours at 80% RH at room temperature under flow-through air. It was then exposed to ammonia and the effective loading was determined.

Pore size distribution: The surface area and pore size distribution analysis were performed on a Micromeritics ASAP 2020 Physisorption Analyzer using BET and T-plot models (N2 @ 77 k). There is no indication that the pore size distribution is altered by the acid treatment.

Aging: the sample was first humidified for 16 hours at 80% RH at room temperature under flow-through air. It was then placed in an open container under stagnant conditions at 80% RH, 45° C. for 7 days. Finally, the sample was re-equilibrated for 16 hours at 15% RH and room temperature. The effective loading of the material was determined before (dry) and after the aging process. The sample did not display any loss in performance after the aging process: the effective loading of the sample actually increased after the aging process.

XPS analysis: In order to assess the effect of the functionalization, XPS analysis was run on the same sample before and after acid treatment. To verify the reproducibility of the treatment, XPS analysis was run on two additional functionalized samples. As anticipated, the XPS analysis for non functionalized CDC indicates that the predominant specie is carbon (95%). Oxygen is also identified (4%) which is probably due to the oxidation step during the CDC fabrication. Finally residual molybdenum was also noted (1%). Upon functionalization, the elemental composition is modified and the amount of oxygen in the sample is drastically increased by a factor 6×, with an amount of oxygen ranging between 15% and 20%. This result is expected as the acid treatment is an oxidation step. The comparison of the types of bonds present prior and after functionalization indicates that the functionalization predominantly introduces carboxylic groups (4×-6×increase).

Boehm titration: The XPS analysis is a surface analysis method. To confirm the presence of acids in the bulk of the material and to characterize the representative functionalities such as carboxylic acid, lactonic acid, and phenolic hydroxyl group, we implemented a multiple-step Boehm titration during which the selective neutralization of each functionality occurs sequentially. The results of the Boehm titration corroborate the XPS results: the amount of carboxylic groups is increased by a factor 6× between the non-functionalized sample and the functionalized sample. The concentration of the other acidic groups (lactone and phenol) remains about constant.

Additional tests were performed to investigate the characteristics of CDC. In particular, there was no loss in effective loading for either residual testing or aging testing. Surface area and pore size analysis indicated that the functionalization occurs inside the pores as expected but it does not modify the pore size distribution. Finally surface analysis (XPS) and bulk analysis (Boehm titration) demonstrated that the functionalization introduces additional oxygen atoms as carboxylic groups.

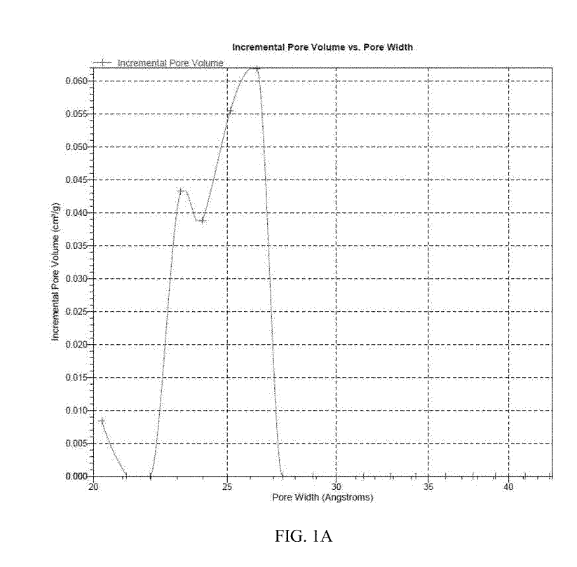

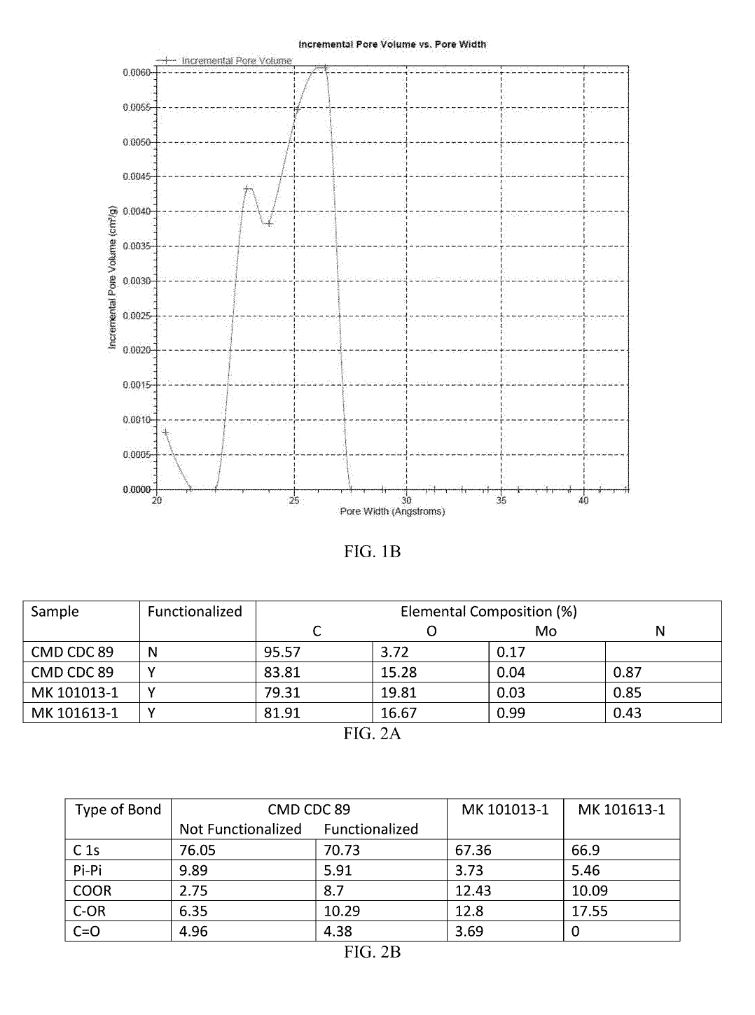

Referring to FIG. 1A, the distribution of the pore volume with regards to pore size distribution of the functionalized material according to one embodiment of the present disclosure is shown. More specifically, the pore width is predominantly comprised between 23 and 27 Angstroms, with local maxima at about 23 Angstroms and about 26.5 Angstroms.

Referring to FIG. 1B, the distribution of the pore volume with regards to pore size distribution of the functionalized material according to one embodiment of the present disclosure is shown. More specifically, the pore width is predominantly comprised between 23 and 27 Angstroms, with local maxima at about 23 Angstroms and about 26.5 Angstroms. The acid treatment does not seem to have altered the pore size distribution.

Referring to FIG. 2A, a table of XPS elemental analysis according to one embodiment of the present disclosure is shown. More particularly, the XPS analysis for non functionalized CDC indicates that the predominant specie is carbon (95%). Oxygen is also identified (4%) which is probably due to the oxidation step during the CDC fabrication. Upon functionalization, the elemental composition is modified and the amount of oxygen in the sample is drastically increased by a factor 6×, with an amount of oxygen ranging between 15% and 20%. This result is expected as the acid treatment is an oxidation step.

Referring to FIG. 2B, a table showing XPS analysis and type of bonding according to one embodiment of the present disclosure is shown. More particularly, The comparison of the types of bonds present prior and after functionalization indicates that the functionalization predominantly introduces carboxylic groups (4×-6× increase).

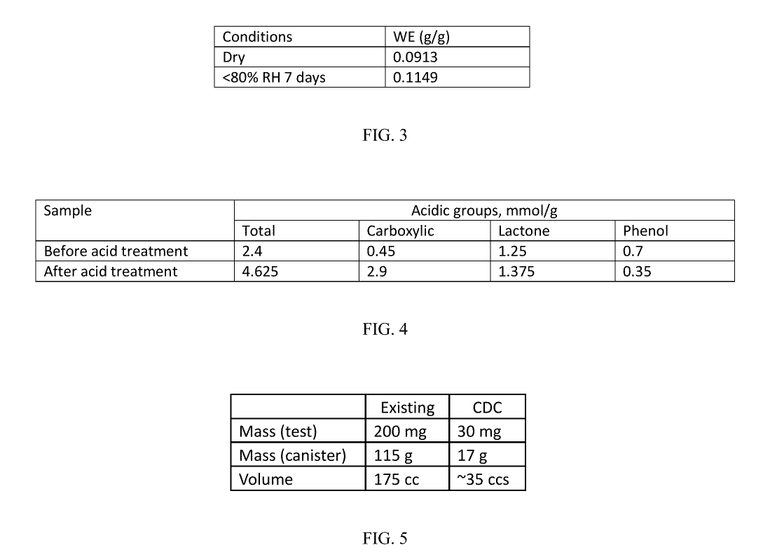

Referring to FIG. 3, a table of results for an aging test according to one embodiment of the present disclosure is shown. More specifically, the sample did not display any loss in performance after the aging process: the effective loading of the sample actually increased after the aging process, demonstrating that the functionalization of the material is a stable process

Referring to FIG. 4, a table of Boehm titration and bulk analysis of different types of acidic groups according to one embodiment of the present disclosure is shown. More specifically, the results of the Boehm titration corroborate the XPS results: the amount of carboxylic groups is increased by a factor 6× between the non-functionalized sample and the functionalized sample. The concentration of the other acidic groups (lactone and phenol) remains about constant.

Referring to FIG. 5, a table comparing existing gas mask filters with CDC filters according to one embodiment of the present disclosure is shown. More specifically, there has been no loss of performance over aging process (e.g., 7 days at 80% RH). In certain embodiments, the CDC is highly tunable and functionalized sorbent provides about a 300% increased adsorption performance and about an 85% weight reduction.

Hazardous high-volatility chemical vapors have very low physical exposure limits but are difficult to capture. The challenge is to develop broad spectrum capture, while reducing size and flow resistance. Currently, multi layers of different sorbents, each specific for given set of products are needed. The layers are usually impregnated with active material. However, the impregnation leads to leaching, thereby decreasing effectiveness over time.

Here, high tunability and permanent functionalization provide a sorption substrate with uniform physical characteristics, broad spectrum capture properties, and water vapor resistant properties. In certain cases, the CDC creates smaller (e.g., 5×) and lighter (e.g., 7×) gas masks for soldiers. In certain embodiments, collective protection also possible and large scale production has been demonstrated.

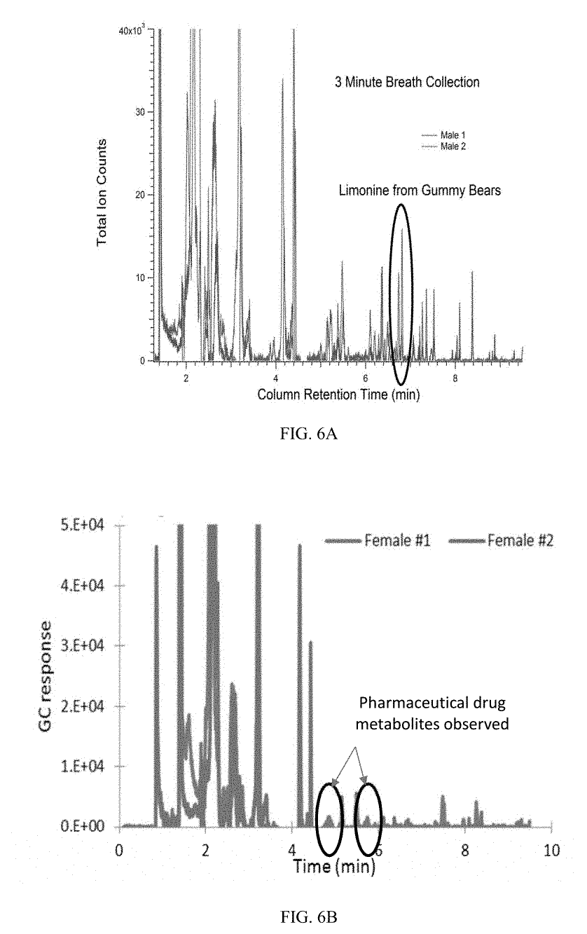

Referring to FIG. 6A, a plot of breath analysis using CDC according to one embodiment of the present disclosure is shown. More particularly, the CDC sorbent material is used for breath analysis, targeting volatile organic compounds linked to agent exposure and clinical ailments. Non-invasive methods are needed for automated and rapid diagnostic evaluation of soldiers before/after deployment in theater triage settings. Volatile organic chemicals (VOCs) in breath have been linked to agent exposure/infection as well as various clinical ailments (e.g., diabetes, cancers (e.g., lung, breast), schizophrenia, cirrhosis, and the like).

Currently, detection of clinical ailments through x-rays, sample collection, tactile examination are required. Exposure to agents usually results in spreading of the infection prior detection. There is currently no rapid noninvasive capability.

Here, the CDC sorbent is a novel broad-spectrum chemical sampling medium that is able to resist water uptake. Broad based VOC air sampling at high humidity has been demonstrated (i.e. a critical capability for breath VOC sampling). Non-invasive diagnostics via breath analysis was not previously available with gold standard sorbent materials.

Referring to FIG. 6B, a plot of breath analysis using CDC according to one embodiment of the present disclosure is shown. More particularly, specific chemical information is observed in CDC sorbent after only three minute breath collections.

While various embodiments of the present disclosure have been described in detail, it is apparent that various modifications and alterations of those embodiments will occur to and be readily apparent to those skilled in the art. However, it is to be expressly understood that such modifications and alterations are within the scope and spirit of the present disclosure, as set forth in the appended claims. Further, the disclosure(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed:

1. A method of chemical sampling comprising,
providing a carbide derived carbon fabricated by partially or completely depleting a metal from a metal carbide composition; and
using the carbide derived carbon as a sorbent and preconcentrator in a high humidity or aqueous environment, wherein the carbide derived carbon retains its removal capabilities at more than 80% relative humidity.

2. The method of chemical sampling of claim 1, wherein the carbide derived carbon is functionalized.

3. The method of chemical sampling of claim 1, wherein the carbide derived carbon sorbent is present in a breath analyzer.

4. The method of chemical sampling of claim 1, wherein the carbide derived carbon sorbent is present in a gas mask.

5. The method of chemical sampling of claim 1, wherein the carbide derived carbon has a pore width of between 23 and 27 Angstroms.

6. A carbide derived carbon material comprising,
a pore width of between 23 and 27 Angstroms; and
chemical removal capabilities that are retained after 7 days at more than 80% relative humidity, wherein the carbide derived carbon is fabricated by partially or completely depleting a metal from a metal carbide composition.

7. The carbide derived carbon of claim 7, wherein the carbide derived carbon is functionalized.

8. The carbide derived carbon of claim 7, wherein the carbide derived carbon is used as a sorbent and preconcentrator in a high humidity or aqueous environment.

9. The carbide derived carbon of claim 8, wherein the carbide derived carbon is used as a sorbent in a breath analyzer.

10. The carbide derived carbon of claim 8, wherein the carbide derived carbon is used as a sorbent in a gas mask.
